(19) United States
(12) Patent Application Publication
(10) Pub. No.: US 2006/0238919 A1
(43) Pub. Date: Oct. 26, 2006

(54) Adaptive data cleaning

(75) Inventor: Randolph L. Bradley, St. Louis, MO (US)

Correspondence Address: SHIMOKAJI & ASSOCIATES, P.C., 8911 RESEARCH DRIVE, IRVINE, CA, 92618, US

(73) Assignee: The Boeing Company

(21) Appl. No.: 11/139,407

(22) Filed: May 27, 2005

Related U.S. Application Data
(60) Provisional application No. 60/673,420, filed on Apr. 20, 2005.

(51) Int. Cl. G11B 5/00

(52) U.S. Cl. 360/128

(57) ABSTRACT

A data cleaning process includes the steps of: validating data loaded from at least two source systems; appending the validated data to a normalized data cleaning repository; selecting the priority of the source systems; creating a clean database; loading the consistent, normalized, and cleansed data from the clean database into a format required by data systems and software tools using the data; creating reports; and updating the clean database by a user without updating the source systems. The data cleaning process standardizes the process of collecting and analyzing data from disparate sources for optimization models enabling consistent analysis. The data cleaning process further provides complete auditablility to the inputs and outputs of data systems and software tools that use a dynamic data set. The data cleaning process is suitable for, but not limited to, applications in aircraft industry, both military and commercial, for example for supply chain management.

### CROSS REFERENCE TO RELATED APPLICATIONS

This application claims the benefit of the U.S. Provisional Application No. 60/673,420, filed Apr. 20, 2005.

### BACKGROUND OF THE INVENTION

The present invention generally relates to data processing and management processes and, more particularly, to an adaptive data cleaning process and system.

The quality of a large real world data set depends on a number of issues, but the source of the data is the crucial factor. Data entry and acquisition is inherently prone to errors both simple and complex. Much effort is often given to this front-end process, with respect to reduction in entry error, but the fact often remains that errors in a large data set are common. The field error rate for a large data set is typically around 5% or more. Up to half of the time needed for a data analysis is typically spent for cleaning the data. Generally, data cleaning is applied to large data sets. Data cleaning is the process of scrubbing data to improve accuracy of a large data set. Ideally, data cleaning should be able to eliminate obvious transcription errors, to correct erroneous entries, such as erroneous part numbers or invalid codes, to update missing data, such as pricing or lead times, and to recognize that there may exist multiple sources and definitions of data. Effective data cleaning should incorporate electronic notes to explain the rational for rule based or manual selections, should provide an audit trail, and should be easy to operate.

Data cleaning is often done using a manual process, which is laborious, time consuming, and prone to errors. Consequently, methods that enable automated detection of errors in large data sets or that assist in detecting errors are of great interest. The process of automated data cleaning is typically multifaceted and a number of problems must be addressed to solve any particular data cleaning problem. Generally, possible error types need to be defined and determined, a search for errors needs to be conducted and the errors need to be identified, and the uncovered errors need to be corrected.

For example, current supply chain software solution vendors, such as i2 Technologies, IBM, Manugistics, MCA Solutions, Systems Exchange, or Xelus have well developed and thought out internal data structures. These structures must be mapped to a customer's source system and must be updated on a periodic basis. The mapping is “hardwired” during implementation, requiring recoding when sources or business rules change. Furthermore, the development of an intermediate database that stores customer data prior to loading into the supply chain software is often needed. Also, current supply chain software solutions do not support archiving results, archiving the inputs that lead to the results, or versioning data over time. This prevents a customer from auditing the decision process which leads, for example, to the stocking recommendations for a piece of heavy equipment, such as aircraft, trucks, ships or machinery. With service part stock levels for repairable items, such as heavy equipment having a long life, running into the tens to hundreds of millions of dollars, auditability is an important requirement for many customers.

Extract, Transform, and Load (ETL) tools are typically used to bridge the gap between source systems and an intermediate database. ETL tools are used to convert data from one operating system and brand of database software to another. ETL tools apply limited business rules to transform and filter data. ETL tools are not designed to handle multiple sources of the same data. Furthermore, when business rules are applied to multiple sources of data, they are applied during the data collection process, which precludes later visibility of changes to more than one source of data. ETL tools also do not support versioning of data, which includes tracking changes in data over time.

In 2000, Ventana Systems, Inc, Harvard, Mass., U.S.A., developed a data cleaning solution for The Boeing Company, Long Beach, Calif., U.S.A. for the supply software solution for the C-17 airlift program. This prior art cleaning solution is written in Oracle and C⁺⁺, with an Excel-like user interface. The data cleaning solution advances the prior art by allowing users to change data in a database and color-coding the data that was changed, by developing a way to allow changes to data to persist over time using simple decision tree logic, and by allowing users to select the data elements, which they wish to clean. Still, this prior art data cleaning solution incorporates several limitations. For example, the supply chain software solution uses global variables that can be changed by any routine versus using data encapsulation, the data cleaning solution uses a complex internal data structure that makes it difficult to maintain, and the loading of the data by the application must adhere to a strict procedure or the data may become corrupted.

As can be seen, there is a need for a method for data cleaning that is automated and enables selection of data from multiple sources. Furthermore, there is a need for a data cleaning process that allows support for archiving results, archiving the inputs that lead to the results, or versioning data over time. Still further, there is a need for a data cleaning process that can be easily implemented into existing data management systems.

There has, therefore, arisen a need to provide a process for data cleaning that offers standardized procedures, that complements corporate common data warehouse projects, and that selects data from multiple sources. There has further arisen a need to provide a process for data cleaning that recognizes that different customers may need to see different sources of ostensibly the same data element, and that there may exist multiple versions of what should theoretically be the same data. There has still further arisen a need to provide a process for adaptive data cleaning that enables archiving both the data used for an analysis and the results of the analysis.

### SUMMARY OF THE INVENTION

In one aspect of the present invention, a data cleaning process comprises the steps of: validating data loaded from at least two source systems using data formatting utilities and data cleaning utilities; appending the validated data to a normalized data cleaning repository; selecting the priority of the source systems; creating a clean database; creating and maintaining a cross-reference between the unique data identifiers; loading consistent, normalized, and cleansed data from the clean database into a format required by data systems and software tools using the data; creating standardized data cleaning and management reports using the consistent, normalized, and cleansed data; and updating the consistent, normalized, and cleansed data by a user without updating the source systems. The clean database contains unique data identifiers for each data element from the at least two source systems.

In another aspect of the present invention, a data cleaning process for a supply chain comprises the steps of: loading data from multiple source systems to a master table of data elements and sources; selecting precedence of the source systems; reviewing high driver and error reports; cleaning logistics data contained in the master table of data elements and sources; approving consistent, normalized, and cleansed data of the master table of data elements and sources and providing the cleansed data to data systems and software tools using the data; initiating inventory optimization of stock level and reorder points using a strategic inventory optimization model using the cleansed data; providing spares analysis including stock level and reorder point recommendations; archiving supporting data for customer audit trail; creating reports; and purchasing spares to cover shortfalls according to the reports.

In a further aspect of the present invention, a data cleaning system includes data formatting utilities, data cleaning utilities, a normalized data cleaning repository, source prioritization utilities, a clean database, cross-reference utilities, and a data cleaning user interface. The data formatting utilities are used to validate data downloaded from at least two source systems. The data cleaning utilities are used to clean the data. The source prioritization utilities are used to select the priority of the at least two source systems. The normalized data cleaning repository receives the formatted and cleansed data. The clean database combines the cleansed and prioritized data. The clean database is a single source of item data containing the best value and unique data identifiers for each data element. The cross-reference utilities are used to create and maintain a cross-reference between the unique data identifiers. The data cleaning user interface enables a user to update the clean database.

These and other features, aspects and advantages of the present invention will become better understood with reference to the following drawings, description and claims.

### BRIEF DESCRIPTION OF THE DRAWINGS

FIG. 1 is a flow chart of a data cleaning high-level architecture according to one embodiment of the present invention;

FIG. 2 is a data cleaning table layout according to one embodiment of the present invention;

FIG. 3 is a high driver analysis matrix according to one embodiment of the present invention;

FIG. 4 is a flow chart of a data cleaning process according to one embodiment of the present invention;

FIG. 5 is a block diagram of a data cleaning application in a supply chain according to another embodiment of the present invention;

FIG. 6 is a flow chart of a data cleaning process for a supply chain according to one embodiment of the present invention; and

FIG. 7 is a flow chart of a spares modeling process according to another embodiment of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

Broadly, the present invention provides an adaptive data cleaning process and system that standardizes the process of collecting and analyzing data from disparate sources for optimization models. The present invention further generally provides a data cleaning process that provides complete auditablility to the inputs and outputs of optimization models or other tools or models that are run periodically using a dynamic data set, which changes over time. The adaptive data cleaning process and system as in one embodiment of the present invention enables consistent analysis, eliminates one time database coding, and reduces the time required to adjust to changing data sources, and may be used, for example, for inventory optimization models or during the development of supply chain proposals. One embodiment of the present invention provides a data cleaning process that is suitable for, but not limited to, applications in aircraft industry, both military and commercial, for example for supply chain management. One embodiment of the present invention provides a data cleaning process that is further suitable for, but not limited to, applications in industries that utilize heavy equipment having a long life. The data cleaning process as in one embodiment of the present invention may be used where a large database needs to be managed, where the database receives data from multiple sources, for example, large corporations that need to combine data from several sub organizations, and where the data to be managed relate to high value goods, such as heavy equipment in transportation industries. The data cleaning process as in one embodiment of the present invention may further be used, for example, for inventory management, order management, consumer data management, or in connection with industrial maintenance.

In one embodiment, the present invention provides a data cleaning process that selects data from multiple sources and uses heuristics based on precedence to select the best source from the multiple sources and to select the best value for forecasting. Existing ETL (Extract, Transform, and Load) tools are not designed to handle multiple sources of the same data. Current ETL tools may load data from multiple sources but require a software developer or user to create custom logic to select one source over another. Furthermore, sources may not be added or deleted after initial implementation of a typical ETL tool without manual intervention of a software developer or user. Contrary to the prior art, the data cleaning process, as in one embodiment of the present invention, allows unlimited numbers of data elements and sources to be added or dropped at any time. Contrary to prior art data cleaning processes, the data cleaning process as in one embodiment of the present invention may recognize that different users, such as customers, may need to see different sources of ostensibly the same data element, such as a unit price, which may have an internal value for buying a part and an external value for selling the part. For this example, both values of the price are valid and which one is used depends upon the application. The data cleaning process as in one embodiment of the present invention may have the ability to display multiple values for selected data elements from different sources. The user may override the original selection with information that may be more accurate than the information in the source system. Unlike traditional databases, where only one value for each data element is visible, the data cleaning process as in one embodiment of the present invention may provide versioning to previous values and traceability to all versions of each data element available from different source systems.

In one embodiment, the present invention provides a data cleaning process that has the ability to capture and identify all changes being made to data elements in the data repository area, and redisplay the changes back to the user. Information about changes to the data element, regardless if the changes are screen changes or mass updates, may be captured by tracking the user changing the data, the date of the change, and comments including why changes were done. This is an advantage over prior art data cleaning processes, which generally allow only flagging the suspected data and which generally require the change to be made to the system of record. In many cases, the system of record is a customer database, or a departmental database, that the data cleaner does not have update authority for. As a result, prior art data cleaning solutions which force the user to update the system of record are often impractical. Contrary to the prior art, the data cleaning process as in one embodiment of the present invention provides dated versioning to both input and outputs to computer models, tracking changes to data over time. Existing ETL tools do not support versioning data over time. The data cleaning process, as in one embodiment of the present invention, allows auditability of both results and the data and data sources upon which the results were based. The data cleaning process, as in one embodiment of the present invention, further ensures data integrity by screening the data against user definable business rules. Furthermore, the data cleaning process, as in one embodiment of the present invention, allows user additions and deletions, for example, to part numbers from source systems, maintaining traceability to what was added and flagging deleted data for traceability, rather than physically deleting the data. Consequently, data is electronically tagged as deleted, but not physically removed from the data repository. Still further, the data cleaning process, as in one embodiment of the present invention, adds automated notes, and allows for manual notes, which may be attached to each data element and provide information on automated processing, format conversions, and other data quality information. This provides auditability when data must be converted for an analysis, for example, when normalizing currency from Great Britain Pounds to United States Dollars.

In one embodiment, the present invention provides a data cleaning process that may be used, for example in connection with supply chain software tools and that may allow archiving and sharing the results of such supply chain software tools. Currently existing data repositories will store current input data required to perform an analysis. The data cleaning process, as in one embodiment of the present invention, will allow archiving both the data used at the time the analysis was performed, and the results of the analysis. This provides complete auditability to the source of data and the model results based upon that data. This is important, for example, for government supply chain contracts and commercial contracts, where auditability to the rational behind the purchase of costly maintenance spares is required. There are no known supply chain tools which support archiving of data and results. In addition, the data cleaning process, as in one embodiment of the present invention allows thresholds and triggers to be established at the data element level providing alerts, which notify, for example, asset managers and data owners that specific data elements are suspect and should be reviewed. These thresholds are particularly important when large amounts of data are being updated, as it may be physically impossible as well as error prone to scan each and every data element for errors. Furthermore, the data cleaning process, as in one embodiment of the present invention provides defaults to fill in critical missing data, while flagging the missing data for manual review. This makes it more likely that all parts will be included in an analysis, compared with traditional solutions of deleting an entire item if any data element for that item is missing or invalid. The data cleaning process, as in one embodiment of the present invention provides traceability to all data elements for which defaults have been used.

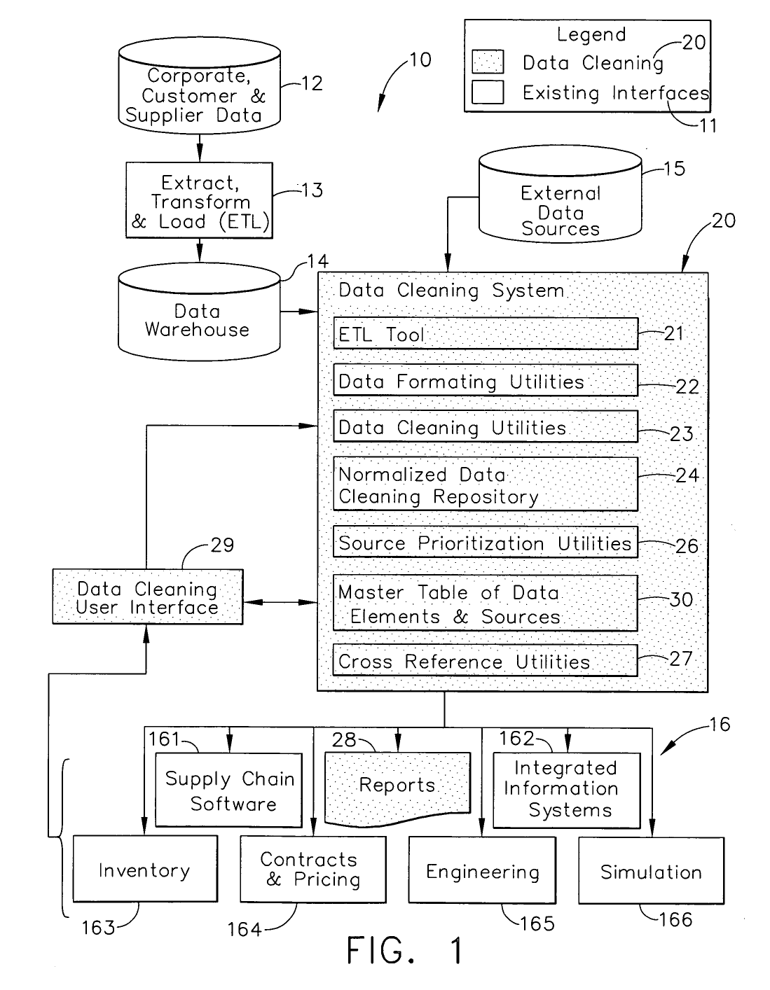

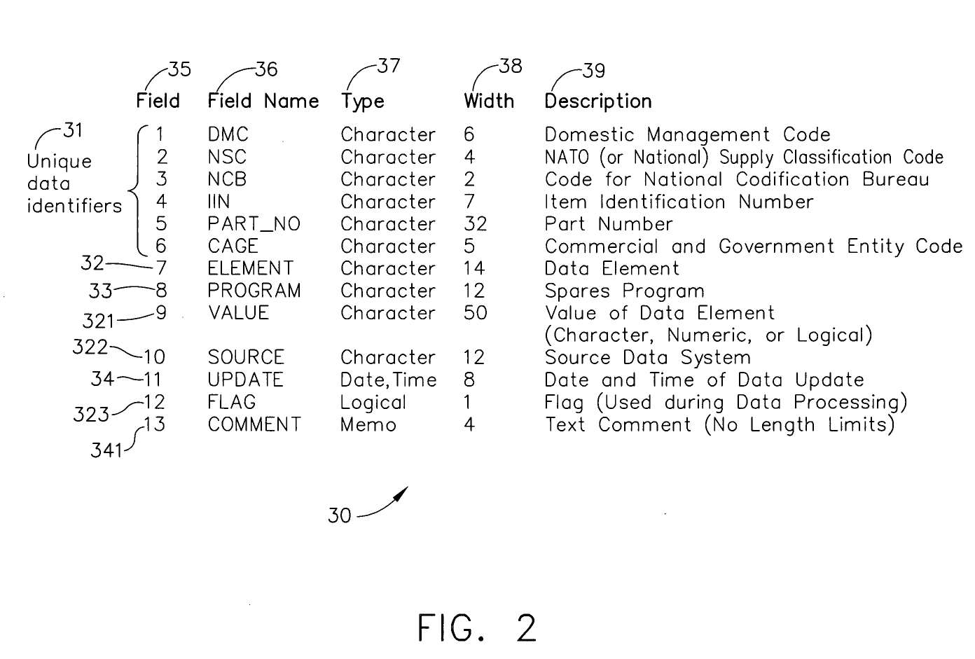

Referring now to FIG. 1, a data cleaning high-level architecture 10 is illustrated according to one embodiment of the present invention. The data cleaning high-level architecture 10 may include a data cleaning system 20 implemented into existing interfaces 11. The data cleaning system 20 may include an ETL (Extract, Transform, and Load) tool 21, data formatting utilities 22, data cleaning utilities 23, a normalized data cleaning repository 24, source prioritization utilities 26, a master table of data elements and sources 30 (also shown in FIG. 2), cross reference utilities 27, reports 28, and a data cleaning user interface 29. The existing interfaces 11 may include corporate, customer and supplier data 12, an ETL tool 13, a data warehouse 14, external data sources 15, and data systems and software tools 16, such as a supply chain inventory optimization system 161, integrated information systems 162, inventory management systems 163, contracts and pricing systems 164, engineering systems 165, and simulation systems 166. The corporate, customer and supplier data 12 may be loaded into data warehouses 14 using the ETL tool 13.

The ETL tool 21 may extract data from the data warehouse 14 or from external data sources 15, may transform the extracted data to a common format for data cleaning, and may load the transformed data into the data cleaning system 20. This operation may also be performed using custom database queries. The data warehouse 14 and the external data sources 15 may be source systems or sources for source data. The data formatting utilities 22 may be used to adjust unique data identifiers to common format as part of the data validation.

The data formatting utilities 22 may account for data entry issues in which slight variations in a unique data identifier, such as inclusion of a dash or blank spaces, may cause identifiers to be interpreted as different items when they should not be.

The data cleaning utilities 23 may be used to clean data from the source systems, such as the data warehouse 14 and the external data sources 15 as part of the data validation. The data cleaning utilities 23 may be used to ensure validity of data loaded from each source system (the data warehouse 14 or the external data sources 15) into data cleaning format.

The normalized data cleaning repository 24 may receive the formatted and cleansed data from different source systems. The normalized data cleaning repository 24 may load cleansed data from different source systems, such as the data warehouse 14 and the external data sources 15, into a master data table.

The source prioritization utilities 26 may be used to select the priority of data sources, such as the data warehouse 14 and the external data sources 15. Source systems, such as the data warehouse 14 and the external data sources 15, may typically be loaded and maintained by disparate organizations, leading to different values being stored for what is ostensibly the same data element 32. This is common both within large organizations with multiple departments, and across customers, suppliers, and government organizations.

The master table of data elements and sources 30 (also shown in FIG. 2) may be created as a clean database combining cleansed and prioritized data from multiple sources. The master table of data elements and sources 30 may be a single source of item data, which contains the best value of each data element 32.

The cross-reference utilities 27 may be used to create and maintain a cross-reference between unique data identifiers 31. Different data sources may use different unique data identifiers 31, such as section reference, NSN (defined as either NATO (North Atlantic Treaty Organization) stock number or national stock number), or part number and manufacturer's code. Often, unique data identifiers 31 will be cross-referenced within a particular data source. This may allow a cross reference to be developed as the clean database is created from multiple sources, such as the data warehouse 14 or the external data sources 15. It may further be possible to create a unique reference number for each item. A one-to-many, many-to-one, or many-to-many relationship in a cross-reference may occur when a unique data identifier 31 on one scheme maps to multiple unique data identifiers 31 on another scheme and vice versa. Consequently the prioritized data cleaning master table of data elements and sources 30 may often contain duplicate unique data identifiers 31. The cross-reference utilities 27 may provide utilities to delete unwanted duplicates and to correct discrepancies in the cross-reference. Furthermore, a unique reference number may be created to enable data systems 16, which are fed data from the data cleaning system 20, to receive a truly unique data identifier number. This may enable data systems 16 and connected applications to execute without requiring that the cross-reference is perfect. Some applications, for example, for an automobile having four tires plus a spare tire, may enable a unique item identifier to be used multiple times. Other applications, for example, a purchasing system, which requires that a particular model tire only list the preferred supplier and most recently quoted price, may require a unique item identifier to occur only once. To solve this problem, an indentured master data item list may be created and maintained. When required, the master data item list allows a unique item identifier to be used multiple times. An example is a list of parts of a military aircraft. For example, a helicopter may contain six rotor blades, three as part of the forward pylon assembly and three as part of the aft pylon assembly. A purchasing system 161 may only need to know the annual buy for rotor blades, while an inventory optimization system 163 may want to know the required demand per blade, and the quantity of blade according to the assembly. A set of utilities may enable duplicate data in the master data item list to be merged with unique item data in the master table of data elements and sources 30 (shown in FIG. 2). The appropriate ratios may be factored in for data elements 32 such as demand rates. This data may then be provided for use in the appropriate software tool, for example the supply chain software 161.

The ETL tool 21 or custom database queries may be used to load the consistent, normalized and cleansed data from the master table of data elements and sources 30 into the format required for data systems and software tools 16, such as supply chain software 161, integrated information systems 162, inventory management systems 163, contracts and pricing 164, engineering 165, and simulation 166.

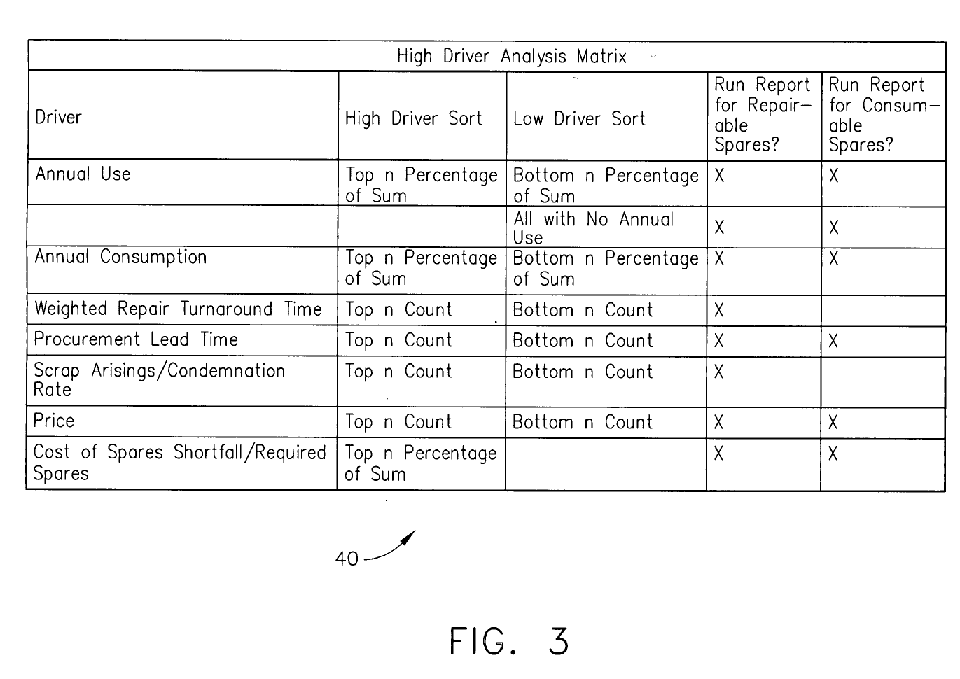

Also, standardized data cleaning and management reports 28 may be created. Often, management reports in one system are similar or even identical to management reports in another system. The data cleaning system 20 may provide some of the most common reports against the master table of elements and sources 30. For example, a line count report may be created that may tally the number of unique item identifiers 31 in the master table of elements and sources 30 (shown in FIG. 2). The line counts may be cross tabulated against different data elements 32. For example, if an inventory management system 163 wants to know the total number of consumable parts and the total number of repairable parts, this information may be drawn from the line count report. In addition, standardized high driver reports 40 (shown in FIG. 3) may be created. The standardized high driver report 40 may enable data to be prioritized for review. The prioritization may enable anomalies to be quickly located when reviewing data for consistency and accuracy.

The data cleaning user interface 29 may enable closed loop data cleaning. Data cleaning is most often performed on the “front line” by users of the execution systems (data systems and software tools 16), such as inventory management 163. These users frequently update data in the course of going for new quotes, or making corrections to data while working with, for example, customers, suppliers, or repair shops. Users must have a way to update the data cleaning system 20 without updating the source systems, such as the data warehouse 14 or the external data sources 15. This may be necessary because the source system, such as the data warehouse 14 or the external data sources 15, is often under control of another organization, or even another customer or supplier. Consequently, it may not be practical or even feasible to update the source system (14 and/or 15). The data cleaning user interface 29 may enable users of data systems and software tools 16, which make decisions based upon the cleansed data provided by the data cleaning system 20, to update the data cleaning system 20. This enables all data systems and software tools 16, for example the supply chain software 161, to maintain consistency based on updates to the cleansed data. Manual updates may be date and time stamped, may include traceability to the user making the update, and may include a common field to capture information deemed important be the user. The data cleaning user interface 29 may be web enabled. The source prioritization utilities 26 may enable data systems and software tools 16, which rely upon information from the data cleaning system 20, to select or not select updates from this user (or users of a particular software tool, such as the supply chain software 161) based upon specific requirements. Manual updates may persist over time during subsequent updates to the source system, such as the data warehouse 14 or the external data sources 15. If the source data stays the same, the data cleaning value may be used. If the source data changes to the same value (within a user specified tolerance band) as the data cleaning value, the source data may be selected and the data cleaning value may be flagged as source system updated. If the source data changes, but is outside the user specified tolerance band, the data element 32 may be flagged for manual review.

The data cleaning system 20 may be integrated into a computer system (not shown). The computer system may be used for executing the utilities, such as the ETL (Extract, Transform, and Load) tools 21, the data formatting utilities 22, the data cleaning utilities 23, the normalized data cleaning repository 24, the source prioritization utilities 26, the master table of data elements and sources 30 (also shown in FIG. 2), and the cross reference utilities 27 as described above. The data cleaning using the data cleaning system 20 may be done using a straightforward spreadsheet file such as a Microsoft Excel file, or database table such as Microsoft ACCESS or FoxPro tables, or via the data cleaning user interface 29.

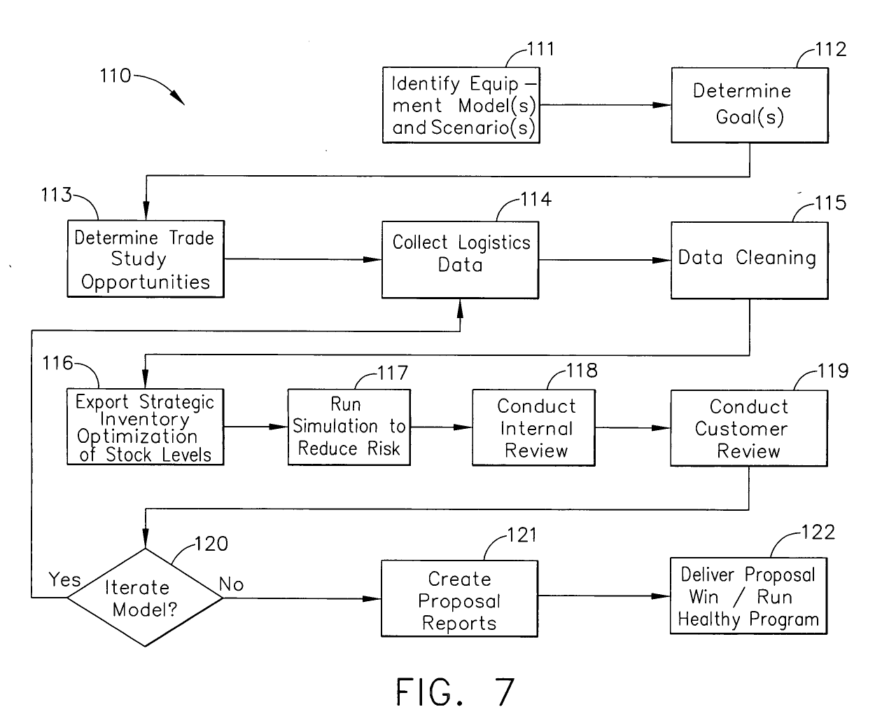

Referring now to FIG. 2, a data cleaning table layout of a master table of data elements and sources 30 is illustrated according to one embodiment of the present invention. The master table of data elements and sources 30 may include a column 35 containing a field number, a column 36 containing a field name, a column 37 containing an entry type, a column 38 containing an entry width, and a column 39 containing a description. The first rows of the table may contain unique data identifiers 31 from one or more indexing schemes. As shown in FIG. 2, for the example given, a part could be uniquely identified by (a) DMC (domestic management code) and IIN (item identification number), (b) NSN (NATO stock number or national stock number), which is comprised of NSC (NATO (or national) supply classification code), NCB (code for national codification bureau), and IIN (item identification number), or (c) Part no. (part number) and CAGE (commercial and government entity code), even though only one unique reference is required. Following the unique data identifiers 31 the data element 32 may be listed followed by a program name 33, such as the spares program 110 (shown in FIG. 7). Further listed in the master table of data elements and sources 30 may be the value 321 of the data element 32, the source 322 of the data element 32 (such as the data warehouse 14 or the external data sources 15, shown in FIG. 1), update information 34, and a flag 323 that may be attached to the data element 32 and that may be used during data processing. The last row of the master table of data elements and sources 30 may contain a text comment 341. The master table of data elements and sources 30 may enable data elements and sources to vary without modifying the code. As a data repository, referential integrity is deliberately not enforced.

Referring now to FIG. 3, a high driver analysis matrix of a high driver report 40 is illustrated according to one embodiment of the present invention. The high driver report 40 may be one of the reports 28 created by the data cleaning system 20, as shown in FIG. 1. The high driver report 40 may be used to prioritize items for review. This may enable the most glaring errors to be rapidly identified, maximizing the often limited review time available. A high driver may sort data elements 32 according to key data drivers, such as annual use, annual consumption, weighted repair turnaround time, procurement lead time, scrap arising/condemnation rate, price, and cost of spares shortfall, as shown in FIG. 3.

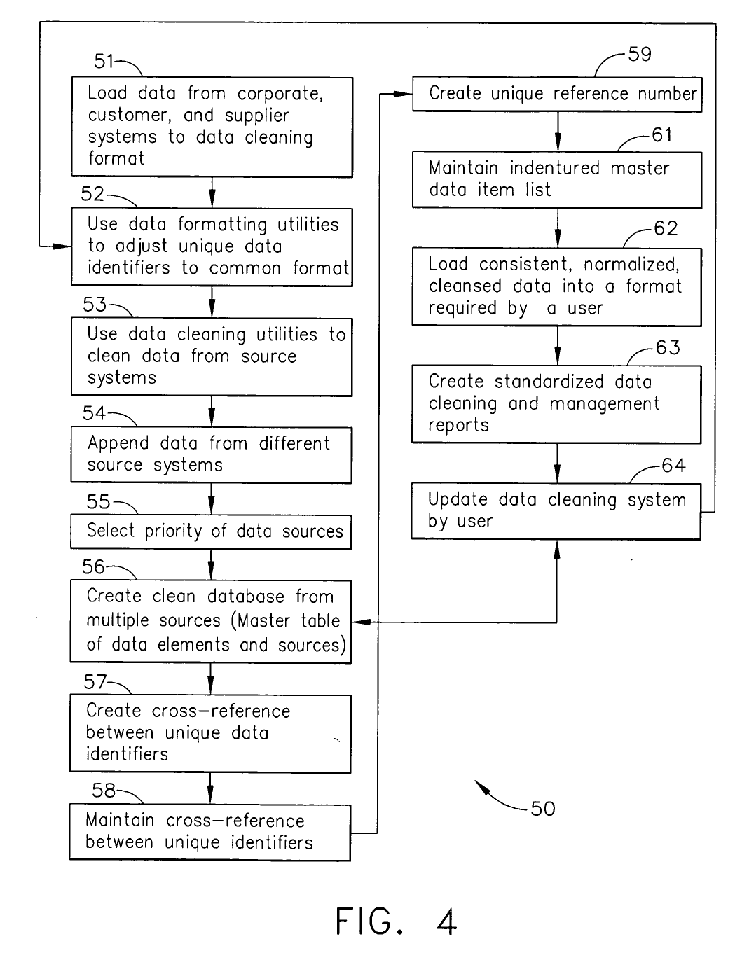

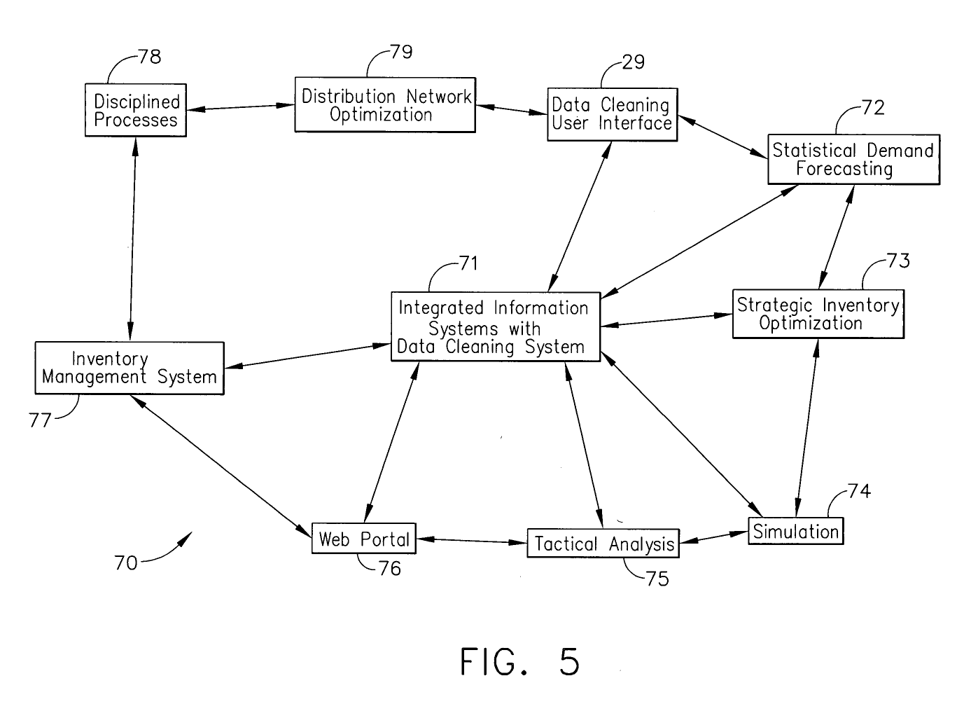

Referring now to FIG. 4, a data cleaning process 50 is illustrated according to one embodiment of the present invention. The data cleaning process 50 may include loading data from corporate, customer, and supplier source systems, such as the data warehouse 14, or from external data sources 15 (shown in FIG. 1) to a common format for data cleaning in a first step 51. Any commercially available ETL tool 21 or custom database queries may be used to perform step 51.

In step 52, data formatting utilities 22 of the data cleaning system 20 (shown in FIG. 1) may be used to adjust unique data identifiers 31 to a common format as part of a data validation process. Step 52 may include deleting leading blanks, converting unique data identifiers 31 (shown in FIG. 2) from numeric fields to character fields as required, and replacing leading zeros stripped if data was loaded as numeric. Step 52 may further include flagging invalid, unrecognized, and missing item identifiers for review. Step 52 may still further include normalizing data to a common format. For example, converting foreign currency to US dollars, escalating historical cost data to current year prices, or converting demands per package quantity to demands per unit of one.

The data cleaning utilities 23 of the data cleaning system 20 (shown in FIG. 1) may be used in step 53 to clean data loaded from the source systems, such as the data warehouse 14 or the external data sources 15 as part of the data validation process. Step 53 may include: reviewing duplicate entries, reviewing difference reports, reviewing differences between data loaded from source systems to validate changes in data and to detect data translation and loading errors, and reviewing differences in the inputs and outputs (source data and results) of software, which uses cleansed data, to identify and understand swings in results caused by changes in the input data. During step 53 duplicate entries may be flagged, conflicting values for data elements may be reviewed by data element 32 (FIG. 2), and manual corrections or updates, which override the source data, may be allowed. In step 53 an automated report, which highlights differences between two data tables by unique data identifiers may be created. Also in step 53, these reports may be prioritized by a specific data element 32 to focus data review on high drivers having the greatest financial impact.

In step 54, the validated and cleansed data may be appended into the normalized data cleaning repository 24 (FIG. 1). The data may be loaded to a master table of the normalized data cleaning repository 24 (FIG. 1). The data may be loaded for each data element 32 (FIG. 2) and for each source system, such as the data warehouse 14 or the external data sources 15 (FIG. 1). Data may not be loaded if the same data was previously loaded from the same source system. Consequently, only the changes are loaded. The date of the data loaded may be added to the source data to enable the most current data to be identified. An option may exist, that if there was an error with the data loaded, to purge all data for a specific data source and reload it. The data to be purged may be displayed for verification first. A user may be authorized as an administrator to be able to delete data to ensure the integrity of the data cleaning system 20 (FIG. 1). The data cleaning system 20 (shown in FIG. 1) may provide traceability to all versions of data from each source system, such as the data warehouse 14 or the external data sources 15. This may provide an audit trail to previous values of data and may allow data to be pulled as of a historical point of time (versioning).

In step 55, the priority of data sources may be selected. Step 55 may include: determining the number of unique data elements 32 (FIG. 2) and determining the number of source systems (such as the data warehouse 14 or the external data sources 15, FIG. 1) for each data element 32. Individual data elements may vary depending upon the application and may vary as the use of the data matures over time. Data sources may vary depending upon the application and may vary as the use and understanding of the quality of the data changes over time. The data cleaning system 20 (FIG. 1) may adapt to the addition and deletion of data elements 32 (FIG. 2) without requiring changes to the software source code. Step 55 may allow the user to update the priority of data sources for a particular data pull, if the data was previously prioritized. Otherwise, step 55 may allow the user to specify the priority of each data source, such as the data warehouse 14 or the external data sources 15 shown in FIG. 1. If data from the first priority source is available, it will be used. Otherwise, data from the second priority source will be selected. Step 55 may further include: allowing the user to specify a conditional statement for selecting data (for example, select the highest value from sources A, B, and C) and allowing the user to select a default to be used in the event that data is unavailable from any source system (such as the data warehouse 14 or the external data sources 15, FIG. 1). A specific data source may not need to be selected if data from that source should not be considered. Step 55 may further include maintaining a historical record of previous prioritizations, so that the data selection scheme used at a point in time in the past may be selected, for example, for audit purposes.

In step 56 a clean database from multiple sources (such as the data warehouse 14 or the external data sources 15, FIG. 1) may be created in the form of the master table of data elements and sources 30 (shown in FIG. 2). The master table of data elements and sources 30 may be a single source of item data, which contains the best value of each data element 32. Step 56 may include maintaining traceability to the source of each data element, recognizing that the source may vary by unique data identifiers 31, maintaining notes that may be attached to each data element to provide additional understanding of the data. If data from the first priority source is available, it may be used. Otherwise, valid data from the next highest priority source may be selected. Maintaining a log of the data source (such as the data warehouse 14 or the external data sources 15, FIG. 1) selected for each unique data identifier 31 may be included in step 56. If valid data does not exist for a data element 32, a user specified default might be selected. The data record may then be annotated that a default was applied. Also in step 56, different applications, such as the supply chain inventory optimization system 161, the inventory management system 163, financial and quoting systems 164, integrated information systems 162, simulation systems 166, or engineering systems 165 (shown in FIG. 1), may be able to select data elements 32 (FIG. 2) with different sequences of prioritization. Each data element 32 may contain, for example, three pieces of information for each unique data identifier 31, such as best value 321, source of the best data 322, and a comment 341, as shown in FIG. 2.

In step 57, a cross-reference may be created between unique data identifiers 31. Step 57 may include prioritizing cross-referenced data based upon the unique data identifier. For example, a scheme may identify the section reference as the best value for describing an item uniquely, followed by a NSN (NATO stock number or national stock number), and followed by a part number and a manufacturer's code.

In step 58, the cross-reference between the unique data identifiers 31 may be maintained by a utility. Step 58 may include reviewing inconsistencies developed when creating a database (master table of data elements and sources 30, FIG. 20) from multiple sources (such as the data warehouse 14 or the external data sources 15, FIG. 1) and identifying a primary unique data identifier for each identification scheme. Reviewing the latest design configuration for parts, for example, part numbers for obsolete part configurations may be converted to the latest design configuration or the latest configuration being sold, may be part of step 58. Furthermore, utilities may be provided to identify all options for cross-referencing based upon data in the data repository, for example, a part number and manufacturer's code may map to multiple NSNs, and a NSN may map to many different part numbers based on the numbering scheme of the different manufacturers that provide parts meeting the specifications of the NSN. Step 58 may further include maintaining index tables as the unique data identifier changes, maintaining index tables as part number and manufacturer's codes are superceded by revised part number and manufacturer's codes, reviewing duplicate part number and manufacturer's code combinations to ensure the part number is not incorrectly cross-referenced to an invalid supplier, and maintaining a master data item list, which may be a list of validated unique data identifiers 31. Items not contained in the master data item list may be flagged for review as suspect.

In step 59, a unique reference number may be created for each data element 32 (FIG. 2) to enable data systems and software tools 16 (FIG. 1), which may be fed data from the data cleaning system 20 (FIG. 1), to receive a truly unique item identification number. Step 59 may further include providing utilities to delete unwanted duplicates and providing utilities to correct discrepancies in the cross-reference. In step 59, applications, such as data systems and software tools 16 (FIG. 1) may be enabled to execute without requiring that the cross-reference needs to be perfect.

In step 61, an indentured master data item list that may contain the unique item identification number may be maintained. When required, the master data item list may allow a unique item identification number to be used multiple times. Step 61 may include merging duplicate item data in the master data item list with unique item data in the master table of data elements and sources 30 (FIG. 2).

In step 62, the consistent, normalized, and cleansed data may be loaded from the master table of data elements and sources 30 (FIG. 2) into a format required by data systems and software tools 16 (FIG. 1) that may use these data. Any commercially available ETL tool 21 (FIG. 1), or custom database queries may be used to perform step 62. As a result, cleansed data, from the same consistent source, which has been normalized to consistent units of measurements, may be available for use by multiple decision making systems, such as the data systems and software tools 16 shown in FIG. 1. Since all decision making systems start out with the same input data provided by the data cleaning system 20 shown in FIG. 1, results may be consistent and valid comparisons may be made between systems, such as the supply chain inventory optimization system 161, the inventory management system 163, financial and quoting systems 164, integrated information systems 162, simulation systems 166, or engineering systems 165 (shown in FIG. 1). Tactical decision making tools, which may enable decisions to be made regarding, for example, individual part numbers may have access to the same data as strategic decision making tools, which may be operated as longer range or global planning system tools.

In step 63, standardized data cleaning and management reports, such as line counts reports and high driver reports 40 (FIG. 3) may be created. Line counts reports may be created by tallying the number or unique item identifiers 31 in the master table of data elements and sources 30 (FIG. 2) and may be cross tabulated against different data elements 32. High driver reports, such as the high driver report 40 shown in FIG. 3, may prioritize items for review and may enable identifying the most obvious errors rapidly.

In step 64, the data cleaning system 20 (FIG. 1) may be updated by a user without updating the source systems, such as the data warehouse 14 and the external data sources 15 (FIG. 1). Step 64 may enable closed loop data cleaning.

Referring now to FIG. 5, a data cleaning application in a supply chain 70 is illustrated according to another embodiment of the present invention. The data cleaning application in a supply chain 70 may be one example for the application of the data cleaning system 20 (shown in FIG. 1) and of the data cleaning process 50 (shown in FIG. 4). The supply chain 70 may include integrated information systems 71 that have a data cleaning system 20 (as shown in FIG. 1) embedded, a data cleaning user interface 29 (also shown in FIG. 1), statistical demand forecasting utilities 72, strategic inventory optimization tools 73, simulation tools 74, tactical analysis utilities 75, a web portal 76, inventory management system 77, disciplined processes 78, and distribution network optimization tools 79. The integrated information systems 71 may receive data from and provide data to the data cleaning user interface 29 (also shown in FIG. 1), to the statistical demand forecasting utilities 72, to the strategic inventory optimization tools 73, to the simulation tools 74, to the tactical analysis utilities 75, to the web portal 76, and to the inventory management system 77. Effective data cleaning may be provided by the data cleaning system 20 (as shown in FIG. 1) embedded within the integrated information systems 71. The data cleaning process 50 (as shown in FIG. 4) may synchronize the supply chain 70 by linking decision support (78, 72), optimization (73, 79), simulation (74), reporting (75, 76), and inventory management tools (77) via a consistent source of normalized, cleansed data.

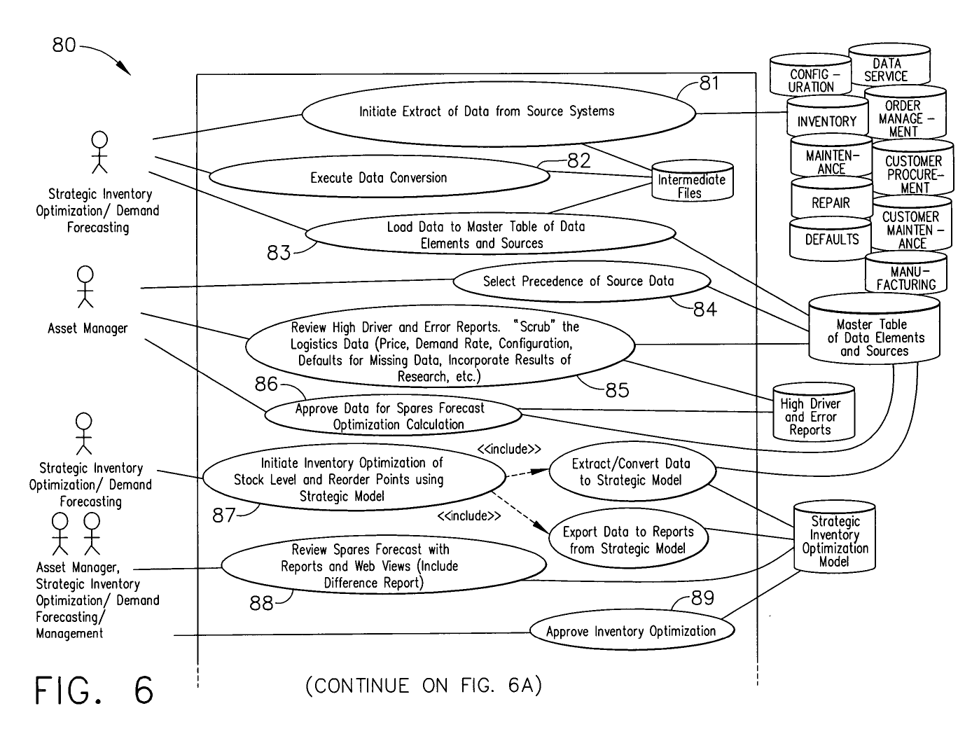

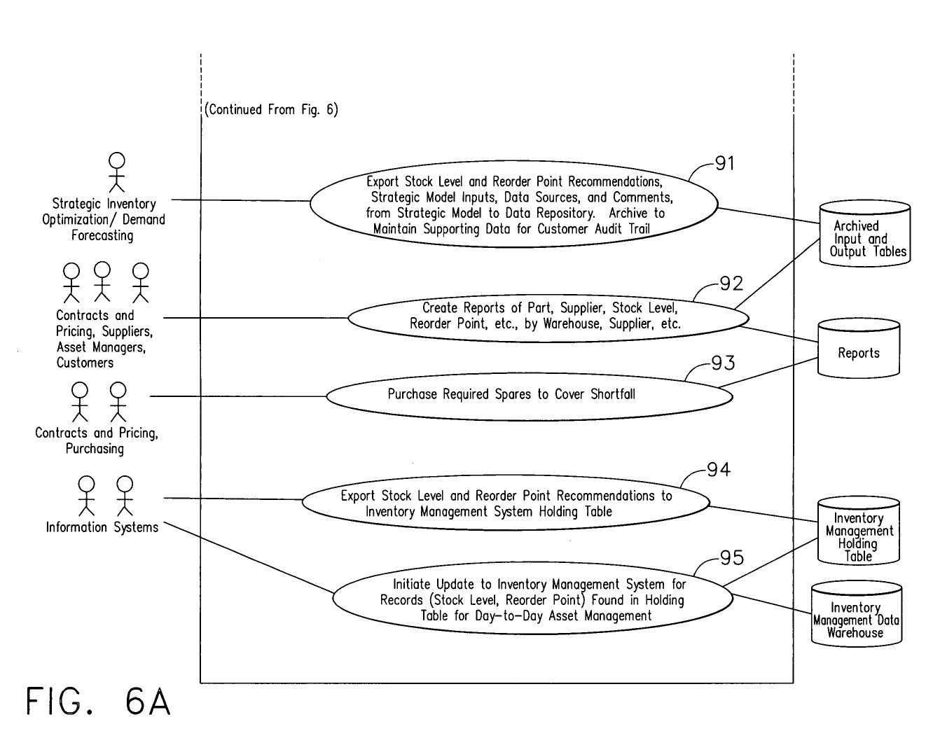

Referring now to FIG. 6, a data cleaning process 80 for a supply chain 70 is illustrated according to one embodiment of the present invention. The data cleaning process 80 for a supply chain 70 may include: initiating the extracting of data from source systems (such as the data warehouse 14 or the external data sources 15, FIG. 1) in step 81 and executing data conversion in step 82 using an ETL tool 21 (FIG. 1). Loading data to a master table of data elements and sources 30 (FIG. 2) may follow in step 83. Step 84 may include selecting the precedence of source data using source prioritization utilities 26 (FIG. 1). Reviewing high driver and error reports and scrubbing the logistics data may be done in step 85. Step 86 may include approving data for a spares analysis optimization calculation followed by initiating inventory optimization of stock level and reorder points by using strategic models in step 87. The spares analysis with reports 28 (FIG. 1) and web views may be reviewed in step 88 and the inventory optimization may be approved in step 89. Step 91 may include exporting stock level and reorder point recommendations, strategic model inputs, source, and comments from a strategic model 73 (FIG. 5), which may be part of the supply chain software 161 (FIG. 1), to data repository 24 (FIG. 1) and archiving all inputs and outputs for maintaining supporting data for customer audit trail. Creating reports 28 (FIG. 1) of part, supplier, stock level, reorder point, etc. by warehouse, supplier, etc. may be done in step 92. In step 93 required spares to cover any inventory shortfall may be purchased and in step 94 stock level and reorder point recommendations may be exported to inventory management system 163 (FIG. 1). In a final step 95, an update to inventory management system 163 (FIG. 1) may be initiated for records found in the holding table for day-to-day asset management.

Referring now to FIG. 7, a spares modeling process 110 is illustrated according to another embodiment of the present invention. The spares modeling process 110 may be an example of the implementation of the data cleaning process 50 (FIG. 4). The spares modeling process 110, which may be part of an inventory management system 163 (FIG. 1), may include: identifying equipment models and scenarios in step 111; determining goals in step 112; and determining trade study opportunities in step 113. Step 114 may include collecting logistics data followed by running a data cleaning process 50 (FIG. 4) in step 115. The strategic inventory optimization of stock levels may be exported in step 116, a simulation 166 (FIG. 1) to reduce risk may be run in step 117, and an internal review may be conducted in step 118. Step 119 may include conducting a customer review followed by deciding if the model should be iterated in step 120. If an iteration of model is desired, step 120 may include going back to step 114. If no iteration of model is needed, creating a proposal report may be done in step 121 followed by delivering proposal, winning proposal, and running a healthy program in step 122. The spares modeling process 110 may provide reliable and actionable results due to the consistent, normalized, and cleansed data provided by the data cleaning process 50 (FIG. 4) in step 115.

It should be understood, of course, that the foregoing relates to exemplary embodiments of the invention and that modifications may be made without departing from the spirit and scope of the invention as set forth in the following claims.

We claim:

1. A data cleaning process, comprising the steps of:
validating data loaded from at least two source systems using data formatting utilities and data cleaning utilities;
appending said validated data to a normalized data cleaning repository;
selecting the priority of said source systems;
creating a clean database containing unique data identifiers for each data element from said at least two source systems;
creating and maintaining a cross-reference between said unique data identifiers;
loading consistent, normalized, and cleansed data from said clean database into a format required by data systems and software tools using said data;
creating standardized data cleaning and management reports using said consistent, normalized, and cleansed data; and
updating said consistent, normalized, and cleansed data by a user without updating said source systems.

2. The data cleaning process of claim 1, further including the steps of:
loading data from said at least two source systems to a common format for data cleaning using an extract, transformation, and load tool;
creating a master table of data elements and sources as a single source of item data containing the best value of each of said data elements;
attaching a note to each of said data elements providing additional understanding of said data element and maintaining notes in said master table of data elements and sources;
maintaining traceability to said source system of each of said data elements;
creating a unique reference number for each of said data elements enabling said data systems and software tools to receive a unique item identification number; and
maintaining an indentured master data item list containing said unique item identification number.

3. The data cleaning process of claim 1, wherein said data validating step further includes the steps of:
normalizing said data loaded from at least two source systems to a common format;
adjusting unique data identifiers to a common format;
flagging invalid, unrecognized, and missing item identifiers for review; and
cleaning said data loaded from at least two source systems.

4. The data cleaning process of claim 1, further comprising the steps of:
providing traceability to all versions of data from each of said source systems; and
providing an audit trail to previous values of data to be pulled as of a historical point of time.

5. The data cleaning process of claim 1, further comprising the steps of:
determining the number of unique data elements;
determining the number of said source systems for each of said unique data elements;
selecting said source system for each of said unique data elements according to a user specified priority;
updating said priority for a particular data pull by the user; and
maintaining a historical record of all prioritizations.

6. The data cleaning process of claim 1, further comprising the steps of:
creating line count reports;
tallying the number of said unique item identifiers in said master table of data elements and sources; and
cross tabulating said unique item identifiers against different data elements.

7. The data cleaning process of claim 1, further comprising the steps of:
creating high driver reports;
prioritizing items for review; and
identifying obvious errors rapidly.

8. The data cleaning process of claim 1, further comprising the step of:
enabling closed loop data cleaning by providing a data cleaning user interface that enables said user to update said master table of data elements and sources.

9. A data cleaning process for a supply chain, comprising the steps of:
loading data from multiple source systems to a master table of data elements and sources;
selecting precedence of said source systems;
cleaning logistics data contained in said master table of data elements and sources based on high driver and error reports;
approving consistent, normalized, and cleansed data of said master table of data elements and sources and providing said cleansed data to data systems and software tools using said data;
initiating inventory optimization of stock level and reorder points using a strategic inventory optimization model using said cleansed data;
providing a spares analysis including stock level and reorder point recommendations;
archiving supporting data for customer audit trail;
creating reports; and
purchasing spares to cover shortfalls according to said reports.

10. The data cleaning process for a supply chain of claim 9, further including the steps of:
extracting said data from said source systems;
executing conversion of said data to a common format for data cleaning; and
reviewing said high driver and error reports.

11. The data cleaning process for a supply chain of claim 9, further including the steps of:
extracting and converting data from said master table of data elements and sources for said strategic inventory optimization model, and
exporting said data from said strategic inventory optimization model to said reports for said spares analysis.

12. The data cleaning process for a supply chain of claim 9, further including the steps of:
approving inventory optimization;
reviewing said spares analysis using reports and web views; and
exporting said stock level and reorder point recommendations, strategic model inputs, source system information, and comments from said strategic inventory optimization model to a data repository.

13. The data cleaning process for a supply chain of claim 9, further including the steps of:
exporting said stock level and said reorder points to an inventory management system; and
updating said inventory management system for said stock level and said reorder points to an inventory management data warehouse for asset management.

14. A data cleaning system, comprising:
data formatting utilities, wherein said data formatting utilities are used to validate data downloaded from at least two source systems;
data cleaning utilities, wherein said data cleaning utilities are used to clean said data;
a normalized data cleaning repository, wherein said normalized data cleaning repository receives said formatted and cleansed data;
source prioritization utilities, wherein said source prioritization utilities are used to select the priority of said at least two source systems;
a clean database, wherein said clean database combines said cleansed and prioritized data, and wherein said clean database is a single source of item data containing the best value and unique data identifiers for each data element;
cross-reference utilities, wherein said cross-reference utilities are used to create and maintain a cross-reference between said unique data identifiers; and
a data cleaning user interface, wherein said data cleaning user interface enables a user to update said clean data base.

15. The data cleaning system of claim 14, further comprising an extract, transform, and load tool, wherein said extract, transform, and load tool extracts said data from said at least two source systems, transforms said data to a common format for data cleaning, and loads said data into said data cleaning system.

16. The data cleaning system of claim 15, wherein said extract, transform, and load tool is used to load said data from said clean database into a format required for data systems and software tools using said data.

17. The data cleaning system of claim 14, wherein said clean database is a master table of data elements and sources.

18. The data cleaning system of claim 17, further comprising standardized data cleaning and management reports, wherein said reports may be created from said data contained in said master table of data elements and sources.

19. The data cleaning system of claim 14, wherein said data cleaning utilities are used to ensure validity of data loaded from said source systems into said data cleaning format.

20. The data cleaning system of claim 14, wherein said source prioritization utilities maintain a historical record of previous prioritizations.

21. The data cleaning system of claim 14, wherein said master table of data elements and sources maintains traceability to the source of each data element.

22. The data cleaning system of claim 14, wherein said data cleaning system receives data from said at least two source systems, wherein said data cleaning system provides consistent, normalized, and cleansed data to said data systems and software tools, and wherein a user may update said data cleaning system without updating said source systems.

23. The data cleaning system of claim 22, wherein said software tool is supply chain software.

24. The data cleaning system of claim 22, wherein said data system is an inventory management system.
